(19) United States
(12) Patent Application Publication
(10) Pub. No.: US 2007/0198875 A1
(43) Pub. Date: Aug. 23, 2007

(54) Method for trunk line duplexing protection using a hardware watchdog

(76) Inventor: Yeong Weon Jung, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/545,895

(22) PCT Filed: Mar. 24, 2004
(86) PCT No.: PCT/KR04/00654

§ 371 Date: Jan. 22, 2007

(30) Foreign Application Priority Data
Mar. 25, 2003 (KR) 10-2003-0018554

(51) Int. Cl. G06F 11/00

(52) U.S. Cl. 714/51

(57) ABSTRACT

The present invention relates to a method for switching dualized trunk lines, more particularly a method for switching dualized trunk lines using a hardware Watchdog function in communication equipments. According to the present invention, trunk interfacing boards are dualized so that a failure of the board does not lead to a failure of the trunk, and switching trunk resources is performed regardless of the failure status of a CPU. More specifically, a method for switching dualized trunk lines using a hardware Watchdog function, comprises the steps of: only monitoring the status of dualized boards via interfaces by a CPU between dualized trunk boards and between processors; performing a response function for a Keep Alive Signal received via trunk line sin real time not to affect a line bandwidth; performing a function for checking a line status and a function for cleaning a Watchdog register at the time of the response; resetting a Watchdog Timer by a sense device register monitoring logic when the CPU writes, which is configured by means of hardware; and generating a timeout in the Watchdog timer in the event that the CPU cannot perform a cleaning operation on the Watchdog register for a predetermined time, thereby switching line sand restarting resources within boards including the CPU. Accordingly, the present invention is a method for switching dualized trunk lines using a hardware watchdog function, which can be applied to a physical line interfacing that requires stability and reliability.

### TECHNICAL FIELD

The present invention relates to a method for switching dualized trunk lines, more particularly a method for switching dualized trunk lines using a hardware Watchdog function in communication equipments. According to the present invention, trunk interfacing boards are dualized so that a failure of the board does not lead to a failure of the trunk, and switching trunk resources is performed regardless of the failure status of a CPU. More specifically, a method for switching dualized trunk lines using a hardware Watchdog function, comprises the steps of: only monitoring the status of dualized boards via interfaces by a CPU between dualized trunk boards and between processors; performing a response function for a Keep Alive Signal received via trunk lines in real time not to affect a line bandwidth; performing a function for checking a line status and a function for cleaning a Watchdog register at the time of the response; resetting a Watchdog Timer by a sense device register monitoring logic when the CPU writes, which is configured by means of hardware; and generating a timeout in the Watchdog timer in the event that the CPU cannot perform a cleaning operation on the Watchdog register for a predetermined time, thereby switching lines and restarting resources within boards including the CPU. Accordingly, the present invention is a method for switching dualized trunk lines using a hardware watchdog function, which can be applied to a physical line interfacing that requires stability and reliability.

### BACKGROUND ART

Generally, the conventional interfacing technology between a control station and a base station or between a control station and a switching center adopts a trunk interfacing, and a failure of the board has often led to a failure of a trunk line.

As such, resources within networks could not be used due to the failure within a board, which consequently led to the failure in the overall system.

Also, the service is inevitably stopped due to the failure of the overall system, thereby degrading the reliability of the system and causing discomforts to its users.

### BRIEF DESCRIPTION OF DRAWINGS

Understanding that these drawings depict only typical embodiments of the invention and are, therefore, not to be considered limiting of its scope, the invention will be described with additional specificity and detail through use of the accompanying drawings in which:

FIG. 1 depicts a block diagram for switching dualized trunk lines using a hardware Watchdog function in accordance with the present invention.

FIG. 2 depicts an inner configuration of a line selection part in accordance with the present invention.

FIG. 3 depicts a block diagram illustrating an interfacing data path in accordance with the present invention.

FIG. 4 depicts a flowchart illustrating the process of switching dualized trunk lines using a hardware Watchdog function in accordance with the present invention.

### DISCLOSURE OF THE INVENTION

The objective of the present invention, which uses a hardware Watchdog function, is to dualize (Load Share) a trunk interfacing board so that a failure of a board does not lead to a failure of a trunk; and to provide a scheme for dualizing interfacing repeaters between a base station and a control station or between a control station and a switching center, by switching trunk resources regardless of a failure status of a CPU, using a hardware Watchdog function. Accordingly, the present invention can be applied to a physical line interfacing that requires stability and reliability

To accomplish the above objective, a method in accordance with the present invention comprises the steps of: only monitoring the status of dualized boards via interfaces by a CPU between dualized trunk boards and between processors; performing a response function for a Keep Alive Signal received via trunk lines in real time not to affect a line bandwidth; performing a function for checking a line status and a function for cleaning a Watchdog register at the time of the response; resetting a Watchdog Timer by a sense device register monitoring logic when the CPU writes, which is configured by means of hardware; and generating a timeout in the Watchdog timer in the event that the CPU cannot perform a cleaning operation on the Watchdog register for a predetermined time, thereby switching lines and restarting resources within boards including the CPU.

In addition, the maintenance for dualized trunk lines in accordance with the present invention is configured so that both an Active/Standby (CPU Restart) type and an Load Share (CPU not Restart) type are possible, and can select overall trunk resources using inter negotiation signals at the time of initial Running; a default at the time of Dual Running maintains the number of selectable resources with a predetermined ratio, which can be controlled by software; in the event that trunk resources are beforehand serviced in a Pair Side Board, the maintenance is performed in a way that the forgoing master controls by means of software control.

Further, the dualization method using the Watchdog, comprises the steps of: determining whether a Link Enable Register specific bit is available after reset; if the bit is unavailable, terminating a Watchdog timer operation for the specific trunk, and if available, matching the timer value of the specific trunk with the value of the Watchdog timer for the trunk; after matching, decreasing the value of the specific trunk timer by one by applying second timer pulses; if the value of the specific trunk timer becomes zero after decreasing by one, cleaning the specific trunk timer, and at the same time, after disabling the specific trunk timer, switching the link of the specific trunk; and after switching the link, terminating the Watchdog timer operation for the specific trunk.

The present invention dualize (Load Share) a trunk interfacing board so that a failure of a board does not lead to a failure of a trunk; and provide a scheme for dualizing interfacing repeaters between a base station and a control station or between a control station and a switching center, by switching trunk resources regardless of a failure status of a CPU, using a hardware Watchdog function. Accordingly, the present invention can be applied to a physical line interfacing that requires stability and reliability.

Also, if trunks are switched using the above configuration, lines can be switched for an abnormal failure status of a CPU, and the present invention can provide a more secure and advanced method than that controlled by a CPU. In addition, by setting a Register called WDPR, which sets a Time Out period, the method can be configured to be able to adjust the switching time, thereby being able to be used more efficiently.

In addition, since the above configuration can be switched in time as required, and can be switched by means of hardware, the real time switching can be performed very rapidly (more rapid than the most rapid switching time by means of software). Also, since the switching can be performed properly by means of software, there is an advantage that the efficiency of maintenance can be improved.

Further, the above configuration can support both an active/standby type and a load share type, thereby providing a dualization maintenance algorithm which is more advanced in technology.

### BEST MODES FOR CARRYING OUT THE INVENTION

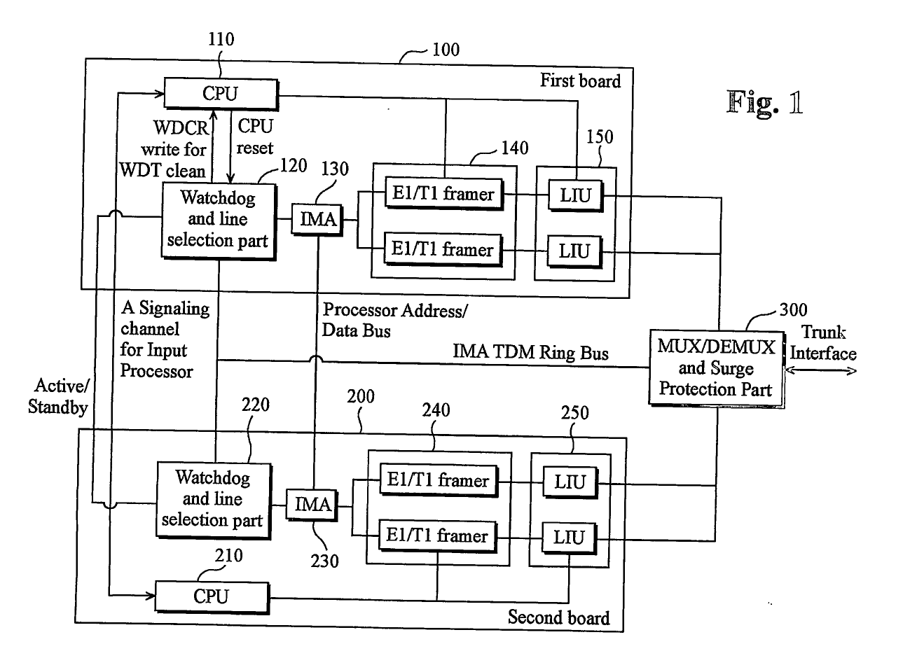

It will be readily understood that the components and steps of the present invention, as generally described and illustrated in the Figures herein and accompanying text, could be arranged and designed in a wide variety of different configurations while still utilizing the inventive concept. Thus, the following more detailed description of the preferred embodiments of the system and method of the present invention, as represented in FIGS. 1 through 4 and accompanying text, is not intended to limit the scope of the invention, as claimed, but it is merely representative of the presently preferred embodiments of the invention. The presently preferred embodiments of the invention will be best understood by reference to the drawings, wherein like parts or steps are designated by like numerals throughout.

FIG. 1 depicts a block diagram for switching dualized trunk lines using a hardware Watchdog function in accordance with the present invention.

As shown in FIG. 1, FIG. 1 includes a first board 100 and a second board 200, which respectively comprises CPU 110 and 210, Watchdog and line selection part 120 and 220, IMA (Inverse Multiplexing over ATM) 130 and 230, E1/T1 framer 140 and 240, LIU (Line Interface Unit) 150 and 250, and multiplexer/demultiplexer and surge protection part 300.

As depicted in the appended Figures, first board 100 and second board 200 are configured in a pair to share common trunk resources, and all information for each other by means of hardware/software. Although it is not shown in Figures, they each other can also share others, such as the detachment/attachment and function fail status.

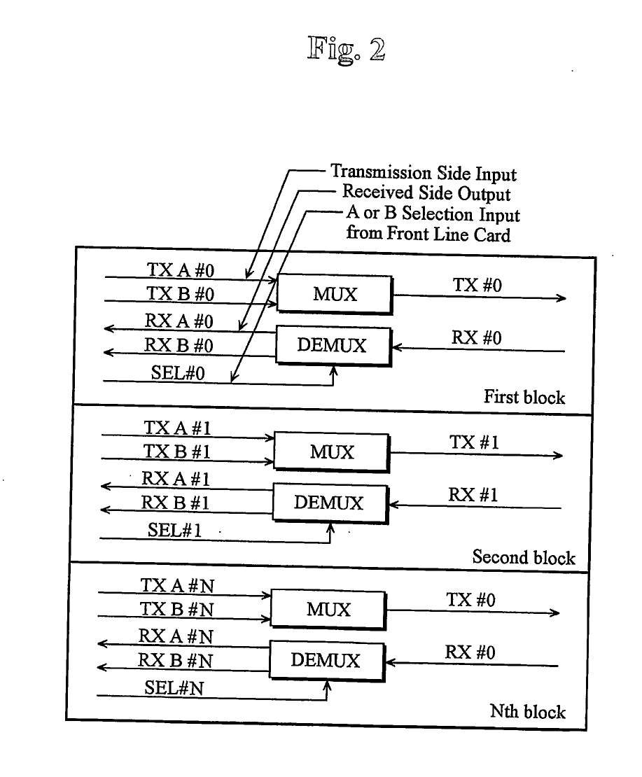

FIG. 2 depicts an inner configuration of a line selection part in accordance with the present invention.

A MUX/DEMUX logic used in each trunk which receives signal lines from first board 100 and second board 200, which are pair boards, is depicted. A board selected by an active signal line controls a selected signal line.

In other words, the active signal line for selecting and switching is controlled by a board that may be called Active of a front part.

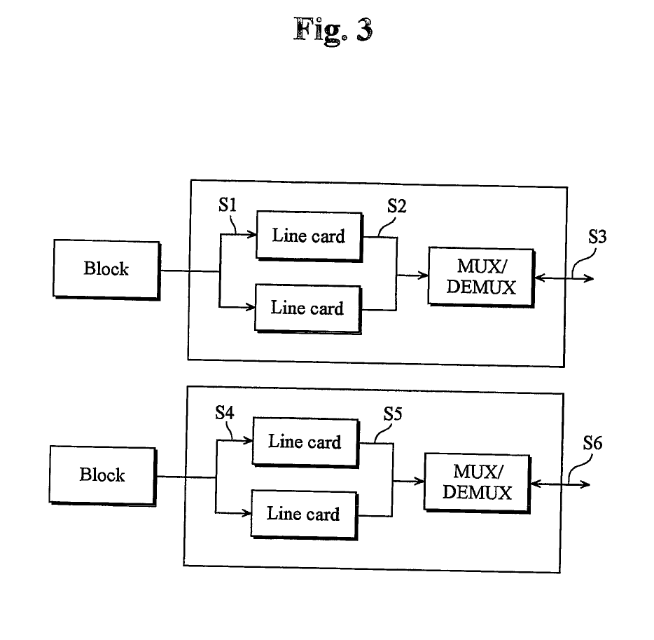

FIG. 3 depicts a block diagram illustrating an interfacing data path in accordance with the present invention.

As depicted in FIG. 3, it includes line cards and multiplexers. Reference number S1 denotes a Multicast Method for CellBus Interface, reference numbers S2 and S5 denote a Wired and Trunk Signal path, reference number S3 denotes an Analog Transmitting Interface for other Network, reference number S4 denotes a Unicast Method for CellBus Interface, and reference number S6 denotes an Analog Receiving Interface for other Network.

FIG. 3 illustrates that in order to maintain the present invention properly as stated above, the Multicast Method denoted by reference number S1 and the Unicast Method denoted by reference number S4 have to be utilized properly.

Herein, generally, the path that transmission (Tx) is performed in the direction of trunk, is called a Reverse Channel, and otherwise is called a Forward Channel.

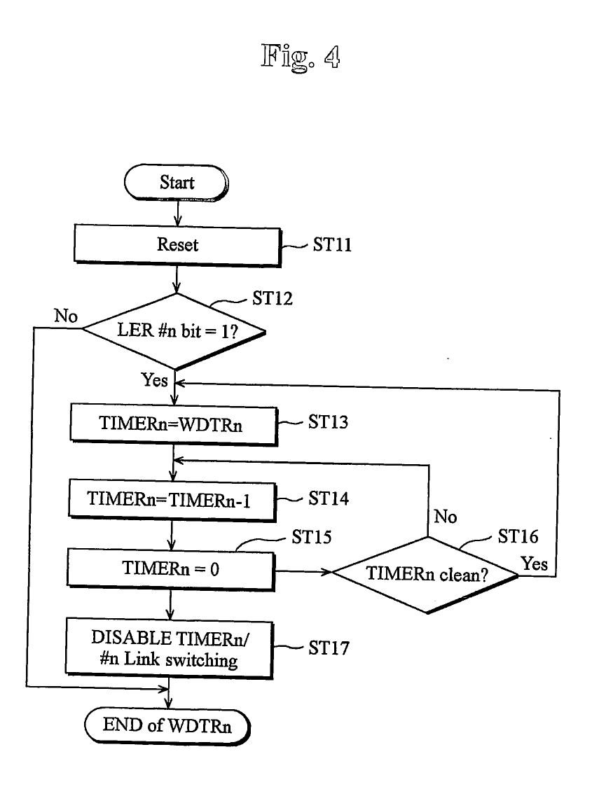

FIG. 4 depicts a flowchart illustrating the process of switching dualized trunk lines using a hardware Watchdog function in accordance with the present invention.

The later-described present invention applies the same algorithm for each link unit. FIG. 4 depicts a flowchart for #n trunk, and as depicted in FIG. 4, the flowchart comprises the steps of: determining (ST12) whether a Link Enable Register #n trunk bit is available after reset (ST11); if the bit is unavailable, terminating a Watchdog timer operation for #n trunk, and if available, matching the timer value of #n trunk with the value of the Watchdog timer for #n trunk (ST13); after matching, decreasing the value of #n timer by one by applying second timer pulses (ST15); if the value of #n trunk timer becomes zero after decreasing by one, cleaning (ST16) #n trunk timer, and at the same time, after disabling #n timer, switching the link (ST17); and after switching the link, terminating the Watchdog timer operation for #n trunk.

The configuration of the present invention and its overall operation as stated above will be described.

The present invention is not an algorithm that a CPU switches trunk lines, etc. by means of software, but a CPU only monitors the status of dualized boards via interfaces between dualized trunk boards and between processors, and has a function for responding to a Keep Alive Signal received via trunk line in real time not to affect a line bandwidth, a function for checking a line status at the time of the response, and a function for cleaning a Watchdog register.

At this time, a sense device register monitoring logic, which is implemented by means of hardware, resets Watchdog Timer when the CPU writes. When the CPU cannot perform a cleaning operation upon the Watchdog register (for a predetermined time), a timeout is generated in the Watchdog timer, thereby switching lines and restarting resources within boards including the CPU.

Now, a maintenance scheme within a system in accordance with the present invention will be described.

An maintenance scheme for the dualization is configured so that both Active/Standby (CPU Restart) type and Load Share (CPU not Restart) type are possible, and can select overall trunk resources using inter negotiation signals at the time of initial Running;

Further, a default at the time of Dual Running maintains the number of selectable resources with a 5:5 ratio, which can be controlled by software, and in the event that trunk resources are beforehand serviced in a Pair Side Board, the maintenance is performed in a way that the forgoing master controls by means of software control.

Herein, logics of hardware blocks for the maintenance within the system will be described.

First, a Watchdog function part comprises a Watchdog Time out Period Register (WTPR), a Watchdog Clean Register (WDCR)/Watchdog Timer, and a Counter Logic.

Next, a switching logic for each line unit in a dualization switching part is performed using a CPU reset function when a Watchdog cleaning operation fails due to an abnormal operation of a CPU or all links fails

Next, a side, which is even (Slot Address), can be configured to be first activated, by having a side delimiter at the time of dual start by default in order to determine an active status of dualization signal lines, dualization signal lines. Such logic design scheme has been studied all these days in various fields and can be utilized properly. This serves as a Global Master for a Watchdog logic including a Pair Side to operate.

Functions of software blocks are described below.

First, inter-watch functions between dualized trunk boards include a status information request function for each other, an Ack function for the status information request (at this time, the line status thereof is reported), and an update function of an information database for trunk resources by the maintenance.

Next, real-time Polling Request/Ack functions between related software blocks via trunk lines include the function that a higher process in the transport layer (network management processor) performs status Request. When it receives Ack, it processes a corresponding B-link status as being normal, and when it does not receive Ack, it processes B-link status as being abnormal. The function that a lower processor in a transport layer performs Ack for a status request.

A software block Watchdog register (WDR) cleaning function can be performed. When the polling function of real-time Polling Request/Ack function between related software blocks via the trunk lines is performed, a lower processor generates a Write event to a WatchDog Register (WDR) before Ack transmission, thereby preventing the timeout of a Watchdog timer from proceeding.

However, the switching of trunk lines in accordance with the present invention as described above can be achieved either by the switching of hardware logics due to a failure of related links, or by the switching using negotiation by means of software (including the bandwidth dispersion).

While the present invention has been described above in conjunction with specific preferred embodiments for a method for switching dualized trunk lines using a hardware Watchdog function, it is evident that numerous alternatives, modifications and variations will be apparent to those skilled in the art without departing from the scope of the present invention. Thus, the breadth and scope of the present invention should not be limited by any of the above-described exemplary embodiments, but should be defined only in accordance with the following claims and their equivalents.

1. A method for switching dualized trunk lines using a hardware Watchdog function, comprising the steps of:
only monitoring the status of dualized boards via interfaces by a CPU between dualized trunk boards and between processors;
performing a response function for a Keep Alive Signal received via trunk lines in real time not to affect a line bandwidth;
performing a function for checking a line status and a function for cleaning a Watchdog register at the time of the response;
resetting a Watchdog Timer by a sense device register monitoring logic when the CPU writes, which is configured by means of hardware; and
generating a timeout in the Watchdog timer in the event that the CPU cannot perform a cleaning operation on the Watchdog register for a predetermined time, thereby switching lines and restarting resources within boards including the CPU.

2. A method as claimed in claim 1, the maintenance for dualized trunk lines is configured so that both an Active/Standby (CPU Restart) type and an Load Share (CPU not Restart) type are possible, and can select overall trunk resources using inter negotiation signals at the time of initial Running;
a default at the time of Dual Running maintains the number of selectable resources with a predetermined ratio, which can be controlled by software;
in the event that trunk resources are beforehand serviced in a Pair Side Board, the maintenance is performed in a way that the forgoing master controls by means of software control.

3. A method as claimed in claim 1, the dualization method using the Watchdog, comprising the steps of:
determining whether a Link Enable Register specific bit is available after reset;
if the bit is unavailable, terminating a Watchdog timer operation for the specific trunk, and if available, matching the timer value of the specific trunk with the value of the Watchdog timer for the trunk;
after matching, decreasing the value of the specific trunk timer by one by applying second timer pulses;
if the value of the specific trunk timer becomes zero after decreasing by one, cleaning the specific trunk timer, and at the same time, after disabling the specific trunk timer, switching the link of the specific trunk; and
after switching the link, terminating the Watchdog timer operation for the specific trunk.
